(19) United States
(12) Patent Application Publication
(10) Pub. No.: US 2024/0273444 A1
(43) Pub. Date: Aug. 15, 2024

(54) DETERMINING RELIABILITY PERFORMANCE INDICES FOR PROCESS PLANTS

(71) Applicant: Saudi Arabian Oil Company, Dhahran (SA)

(72) Inventor: Walid Ali Alghamdi, Dhahran (SA)

(21) Appl. No.: 18/167,515

(22) Filed: Feb. 10, 2023

(51) Int. Cl. G06Q 10/0639

(52) U.S. Cl. CPC G06Q 10/06393

(57) ABSTRACT

To determine a reliability performance index for a process plant, from multiple sources, numerical input values representing a reliability of multiple assets operating in the process plant is received. The numerical input values are classified into multiple reliability elements. Using the numerical input values, a quantitative score is determined for each reliability element of the multiple reliability elements. Each quantitative score for each reliability value is adjusted by a weight assigned to the reliability element. The quantitative score is aggregated for each reliability element to determine an aggregate score. Demerits directed to receiving the numerical input values after a threshold duration or directed to lack of integrity of the received numerical input values are deducted, resulting in a total score measuring a reliability of the process plant. The total score is provided as an output in response to receiving the numerical input values.

### TECHNICAL FIELD

This disclosure relates to computer-implemented methods, software and systems for evaluating resources utilized in operating process plants, e.g., gas processing plants, and determining reliability performance indices that measure operational levels and readiness of such process plants.

### BACKGROUND

Process plants, e.g., gas processing plants, need to operate reliably to maintain production requirements, prevent unscheduled maintenance and repair, avoid costly accidents and prevent environmental damage. Process plants deploy several assets (machinery and people). One measure of a plant's reliability is the total operating time of an asset by a number of asset failures over a given period of time.

### SUMMARY

This disclosure describes determining reliability performance indices for process plants.

Certain aspects of the subject matter described here can be implemented as a computer-implemented method implemented in a process plant deploying multiple assets operating collectively to perform process plant operations. From multiple sources, numerical input values representing a reliability of multiple assets operating in the process plant is received. The numerical input values are classified into multiple reliability elements. Using the numerical input values, a quantitative score is determined for each reliability element of the multiple reliability elements. Each quantitative score for each reliability value is adjusted by a weight assigned to the reliability element. The quantitative score is aggregated for each reliability element to determine an aggregate score. Demerits directed to receiving the numerical input values after a threshold duration or directed to lack of integrity of the received numerical input values are deducted, resulting in a total score measuring a reliability of the process plant. The total score is provided as an output in response to receiving the numerical input values.

An aspect combinable with any other aspect includes the following features. The multiple reliability elements includes a reliability workforce element, a preemptive work element, a preventive work element, a predictive work element, a diagnostic work element, a corrective work element, a continuous improvement work element, a management of recommendations element, a data assessment element, a key performance indicator element, a field assessment and physical condition verification element, an equipment trips element and a knowledge sharing element.

An aspect combinable with any other aspect includes the following features. A reliability workforce element score for the reliability workforce element is determined using Eq. 1 discussed below.

An aspect combinable with any other aspect includes the following features. A preemptive work element score for the preemptive work element is determined using Eq. 2 discussed below.

An aspect combinable with any other aspect includes the following features. A preventive work element score for the preventive work element is determined using Eq. 3 discussed below.

An aspect combinable with any other aspect includes the following features. A predictive work element score for the predictive work element is determined using Eq. 6 discussed below.

An aspect combinable with any other aspect includes the following features. A diagnostic work element score for the diagnostic work element is discussed using Eq. 13 discussed below.

Certain aspects of the subject matter described here can be implemented as a computer-readable medium storing computer instructions which when executed by one or more processors is configured to perform methods discussed here. Certain aspects of the subject matter described here can be implemented as a computer system including one or more processors and a computer-readable medium storing computer instructions which when executed by the one or more processors is configured to perform methods discussed here.

While generally described as computer-implemented software embodied on tangible media that processes and transforms the respective data, some or all of the aspects may be computer-implemented methods or further included in respective systems or other devices for performing this described functionality. The details of these and other aspects and implementations of the present disclosure are set forth in the accompanying drawings and the description below. Other features, objects, and advantages of the disclosure will be apparent from the description and drawings, and from the claims.

### BRIEF DESCRIPTION OF THE DRAWINGS

FIG. 1 is a table showing a breakdown of quantitative scores when evaluating a PRPI for a process plant.

FIG. 2 is a computing environment to evaluate the PRPI for the process plant.

FIG. 3 is a table showing criteria and scoring evaluations for a first element measured to evaluate the PRPI for the process plant.

FIG. 4 is a table showing criteria and scoring evaluations for a second element measured to evaluate the PRPI for the process plant.

FIG. 5 is a table showing criteria and scoring evaluations for a third element measured to evaluate the PRPI for the process plant.

FIG. 6 is a table showing criteria and scoring evaluations for a fourth element measured to evaluate the PRPI for the process plant.

FIG. 7 is a table showing criteria and scoring evaluations for a fifth element measured to evaluate the PRPI for the process plant.

FIG. 8 is a table showing criteria and scoring evaluations for a sixth element measured to evaluate the PRPI for the process plant.

FIG. 9 is a table showing criteria and scoring evaluations for a seventh element measured to evaluate the PRPI for the process plant.

FIG. 10 is a table showing criteria and scoring evaluations for an eighth element measured to evaluate the PRPI for the process plant.

FIG. 11 is a table showing criteria and scoring evaluations for a ninth element measured to evaluate the PRPI for the process plant.

FIG. 12 is a table showing criteria and scoring evaluations for a tenth element measured to evaluate the PRPI for the process plant.

FIG. 13 is a table showing criteria and scoring evaluations for an eleventh element measured to evaluate the PRPI for the process plant.

FIG. 14 is a table showing criteria and scoring evaluations for a twelfth element measured to evaluate the PRPI for the process plant.

FIG. 15 is a table showing criteria and scoring evaluations for a thirteenth element measured to evaluate the PRPI for the process plant.

Like reference numbers and designations in the various drawings indicate like elements.

### DETAILED DESCRIPTION

This disclosure describes computer-implemented methods, computer-readable media and computer systems for comparative evaluation of reliability programs effective index of a process plant, e.g., a gas processing plant. The plant reliability performance index (PRPI) is a quantitative score that assists plant operators to identify gaps and improvement opportunities in reliability programs. The PRPI score serves as a platform to identify and share reliability excellence, best practices, and lessons learned among other process plants and organizations that operate such plants. The PRPI score also serves as a basis to transform reliability performance from reactive to proactive.

As described below, evaluating reliability programs effective index to determine PRPI for a process plant includes obtaining, from multiple sources (e.g., sensors disposed at different locations within the process plant), measurements of various variables that collectively represent plant performance and reliability. As described below, to determine the PRPI score, a computer system obtains measurements from thirteen different sources (also called “Elements”). Each element is assigned a maximum score. Based on measurements obtained from sensors disposed at each source, a quantitative performance measure is determined for each element. A total score is determined for the process plant as a summation of the quantitative performance measure for each element with deductions for late submission of measurements and measurements of poor quality.

Thus, PRPI is a score-based methodology to measure the reliability programs performance and effectiveness in assets (including corporate assets) used to operate a process plant. The index is a measure using which an evaluator can evaluate the performance, effectiveness and compliance of reliability programs in different assets within a process plant, identify and share reliability excellence best practices between assets, enhance workforce competencies and transform reliability performance reactive to proactive. The PRPI is a quantitative measure to gauge the reliability performance. The PRPI serves as a quantitative framework that represents score for weight distributed focus areas, namely, reliability workforce, reliability unit effectiveness, continuous improvement, plant reliability and knowledge sharing. As described below, each of these focus areas covers multiple elements.

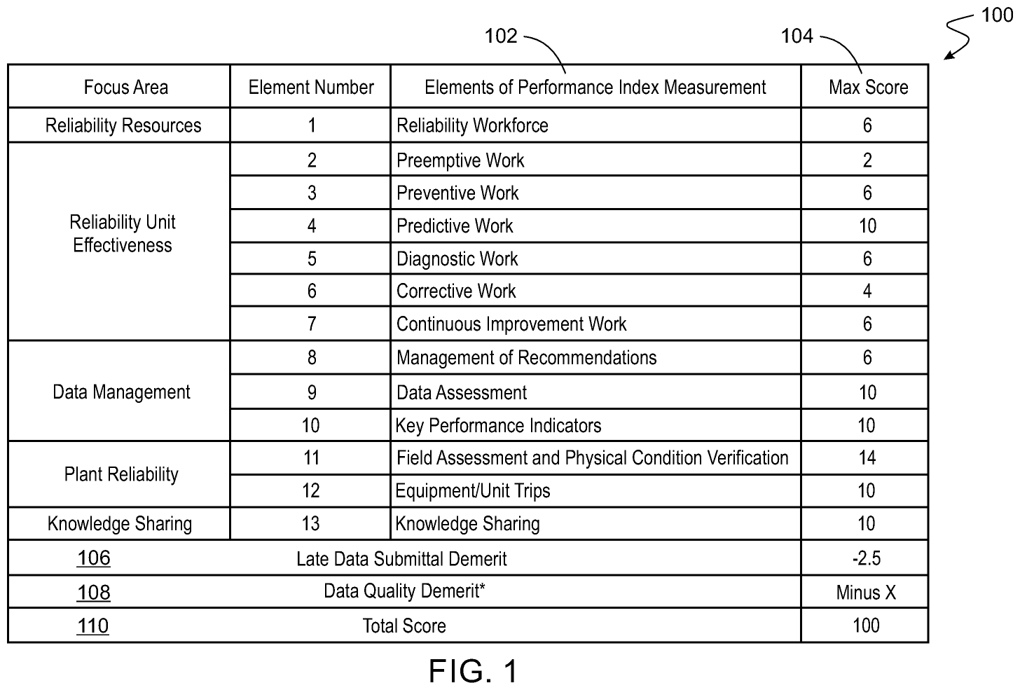

FIG. 1 is a table 100 showing a breakdown of quantitative scores when evaluating a PRPI for a process plant. The table 100 includes column 102 listing thirteen elements from which measurements are received. The elements include (1) reliability workforce, which is an element in the reliability resources focus area. The elements include (2) preemptive work, (3) preventive work, (4) predictive work, (5) diagnostic work, (6) corrective work and (7) continuous improvement work, which are elements in the reliability unit effectiveness focus area. These elements include (8) management of recommendations, (9) data assessment and (10) key performance indicators, which are elements in the data management focus area. The elements include (11) plant reliability and (12) equipment/unit trips, which are elements in the plant reliability focus area. The elements include (13) knowledge sharing, which is an element in the knowledge sharing focus area. The table 100 includes column 104, which includes the maximum scores assignable to each element are shown adjacent to each element in the table. The table 100 includes row 106, which lists a maximum of −2.5 demerits can be assigned for late submission of measurements for each element. Each element is associated with a data quality demerit resulting from measurements that lack data integrity. The data quality demerit is included in row 108 of the table 100. The total score (row 110), which is a quantitative measure of the PRPI, is determined by adding the scores for each element and subtracting any score related to late data submission or lack of data quality.

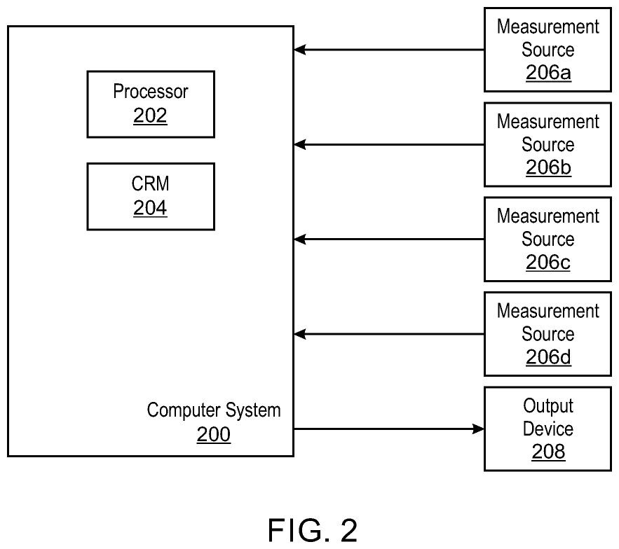

FIG. 2 is a computing environment to evaluate the PRPI for the process plant. The computing environment includes a computer system 200, which includes one or more processors (e.g., the processor 202) and a computer-readable medium 204 (e.g., non-transitory computer-readable medium) storing instructions executable by the one or more processors. The computer system 200 can be operatively coupled (e.g., via wired or wireless networks) to multiple measurement sources (e.g., measurement sources 206a, 206b, 206c, 206d). Each measurement source can be a sensor associated with a respective element listed in the table shown in FIG. 1. In some implementations, each element can be associated with multiple sensors. The computer system 200 can receive the measurements from each sensor as input. By executing computer instructions (described later) stored on the computer-readable medium 204, the processor 202 can process the input from the sensors to determine a measurement score for each element. The processor 202 can perform mathematical operations (described later) to combine the scores received for each element to determine a total score that represents the PRPI for the process plant. The computer system 200 is operatively coupled to an output device 208 (e.g., a display device) to which the computer system 200 transmits the total score determined by performing the mathematical operations.

In some implementations, the computer system 200 can periodically (e.g., once or multiple times per minute, once or multiple times per hour, once or multiple times per day, once or multiple times per week) receive measurements from the multiple sensors and update the PRPI quantitative score at the same frequency as which the measurements are received. In some implementations, in addition to providing the PRPI quantitative score, the computer system 200 can identify an element or elements with scores below a threshold score to allow a plant operator to pay particular attention to underperforming assets. In some implementations, the computer system 200 can receive the measurements automatically from the sensors, i.e., without human intervention. In some implementations, the computer system 200 can receive the measurements as manual inputs from a human operator.

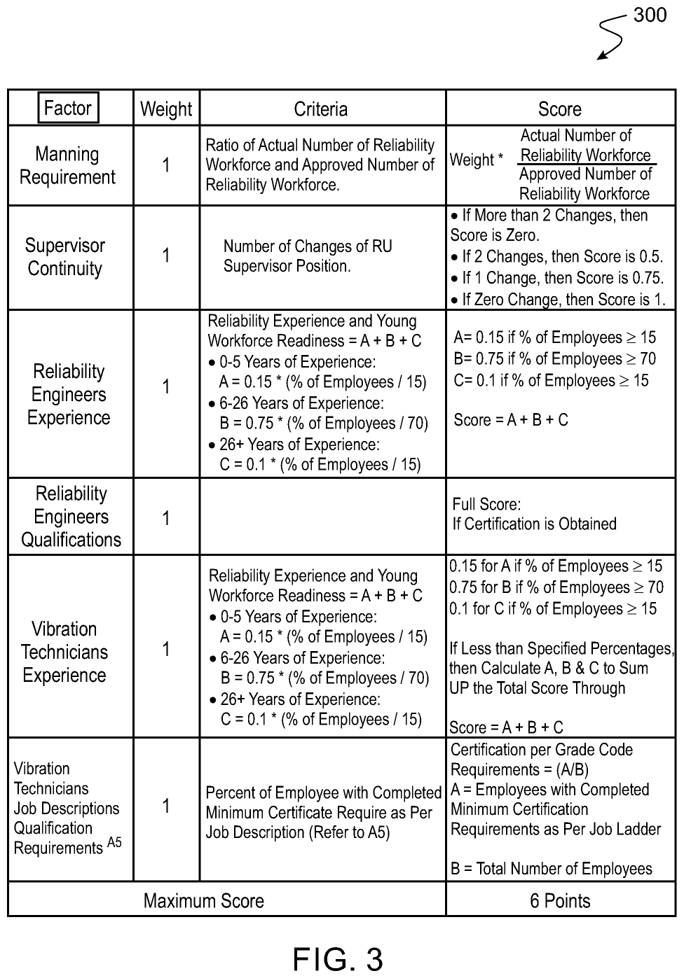

FIG. 3 is a table 300 showing criteria and scoring evaluations for a first element, namely, the reliability workforce element, measured to evaluate the PRPI for the process plant. A maximum score allocated to the reliability workforce element score is 6. The first factor evaluated to determine the reliability workforce element score for the process plant is manning requirement. The manning requirement measures a ratio of actual number of reliability workforce and approved number of reliability workforce. In this context, “workforce” means personnel (e.g., engineers and technicians) working in the reliability unit within the process plant. A weight of 1 (one) is assigned to the manning requirement score. The manning requirement score is determined according to Eq. 1.

$${Score}_{Manning Requirement} = Weight \times \frac{Actual number of reliability work force}{Approved number of reliability work force} \qquad ( Eq . 1 )$$

The manning requirement factor score represents adequate reliability resources to support the implementation of the reliability programs. The approved number of reliability workforce means the approved manning level of personnel that should be available and maintained in the reliability unit within the organization.

In some implementations, the computer system 200 (FIG. 2) receives as input, the actual number of reliability workforce and the approved number of reliability workforce. For example, the input can be automatic or manual entry of the actual and approved number of personnel via an input device. The computer system 200 stores the weight assigned to the manning requirement score. Using the input and the weight, the computer system 200 executes Eq. 1 to determine the manning requirement score. The computer system 200 stores the manning requirement score in the CRM 204.

The second factor evaluated to determine the reliability workforce element score for the process plant is supervisor continuity. The supervisor continuity is measured by the number of changes in permanent and acting supervisors of a reliability unit (e.g., an asset or a collection of assets) within the last one year. Few to no changes indicates a higher supervisor continuity score and vice versa. A change shall not affect the supervisor continuity score if the change resulted in onboarding a supervisor who was a supervisor of another reliability unit in the process plant, the change resulted in onboarding another employee of the reliability unit to the supervisor level or the change resulted from an acting assignment of less than 90 days.

In some implementations, the computer system 200 (FIG. 2) receives as input, the number of changes to the supervisor role of the reliability unit. For example, the input can be automatic or manual entry of the number of changes. The computer system 200 determines a supervisor continuity score according to the following rules—(i) changes>2→score=0; (ii) changes=2→score=0.5; (iii) changes=1→score=0.75; (iv) changes=0→score=1. Further, the computer system 200 assigns a weight of 1 (one) to the final supervisor continuity score. The computer system 200 stores the supervisor continuity score in the CRM 204.

The third factor evaluated to determine the reliability workforce element score for the process plant is reliability engineers experience score. This score accounts for the qualifications of reliability engineers assigned to operate a reliability unit. For example, the qualifications can include educational levels (e.g., B.S., M.S., Ph.D. in a relevant field) or vocational training certifications issued to reliability engineers, e.g., Machinery Lubrication Specialist, Certified Reliability Leader, Asset Reliability Practitioner, to name a few. The reliability engineers experience score also accounts for a number of years for which a reliability engineer has been practicing in their respective field.

In some implementations, the computer system 200 (FIG. 2) receives as input, the number of years of each reliability engineer in the reliability unit. For each reliability engineer, the computer system 200 determines scores A, B and C according to the following rules—(i) Experience=0-5 years→A=(0.15×(percentage of employees/15)); (ii) Experience=6-26 years→B=(0.75×(percentage of employees/70)); (iii) Experience >26 years→C=(0.1×(percentage of employees/15)). Having determined scores A, B and C, the computer system 200 determines a reliability engineers experience score as A+B+C. The computer system 200 assigns a weight of 1 (one) to the reliability engineers experience score. The computer system 200 stores the reliability engineers experience score in the CRM 204.

The fourth factor evaluated to determine the reliability workforce element score is a reliability engineers qualification score. The reliability engineers qualification score is related to the reliability engineers experience score. If a reliability engineer has obtained a certification related to the reliability engineer's responsibilities in the reliability unit, then the reliability engineers qualification score is one. Otherwise, the score is zero. In some implementations, the computer system 200 (FIG. 2) receives as input and for each reliability engineer in the reliability unit, whether or not the reliability engineer has a qualifying certification. If yes, then the computer system 200 assigns a reliability engineers qualification score of 1. If no, then the computer system 200 assigns a reliability engineers qualification score of 0. The computer system 200 assigns a weight of 1 (one) to the reliability engineers qualification score. The computer system 200 stores the reliability engineers qualification score in the CRM 204.

The fifth factor evaluated to determine the reliability workforce element score for the process plant is vibration technicians experience score. This score accounts for the qualifications of vibration technicians assigned to monitor vibrations in machinery operating in a reliability unit. Similar to the reliability engineers experience score, the vibration technicians experience score also accounts for a number of years for which a vibration technician has been practicing in their respective field.

In some implementations, the computer system 200 (FIG. 2) receives as input, the number of years of each vibration technician in the reliability unit. For each vibration technician, the computer system 200 determines scores A, B and C according to the following rules—(i) Experience=0-5 years→A=(0.15×(percentage of employees/15)); (ii) Experience=6-26 years→B=(0.75×(percentage of employees/70)); (iii) Experience >26 years→C=(0.1×(percentage of employees/15)). Having determined scores A, B and C, the computer system 200 determines a vibration technicians experience score as A+B+C. The computer system 200 assigns a weight of 1 (one) to the vibration technician experience score. The computer system 200 stores the vibration technician experience score in the CRM 204.

The sixth factor evaluated to determine the reliability workforce element score is a vibration technicians qualification score. The vibration technicians qualification score is related to the vibration technicians experience score. The vibration technicians qualification score measures a percentage of certified vibrations technicians from among all vibration technicians in a reliability unit.

In some implementations, the computer system 200 (FIG. 2) receives as input, the total number (B) of vibration technicians in the reliability unit. The computer system 200 (FIG. 2) also receives as input, the number (A) of vibration technicians in the reliability unit with the requisite certifications. If all the vibration technicians in the reliability unit are certified, then the vibration technician qualification score is 1 or 100%. The computer system 200 determines a ratio of A/B as a percentage. The computer system 200 assigns a weight of 1 (one) to the vibration technicians qualification score. The computer system 200 stores the vibration technician qualification score in the CRM 204.

Having determined a score for each of the six factors as described above, the computer system 200 determines the reliability workforce element score as a summation of the score determined for each factor. The maximum score for each factor is 1. Therefore, the maximum reliability workforce element score can be 6.

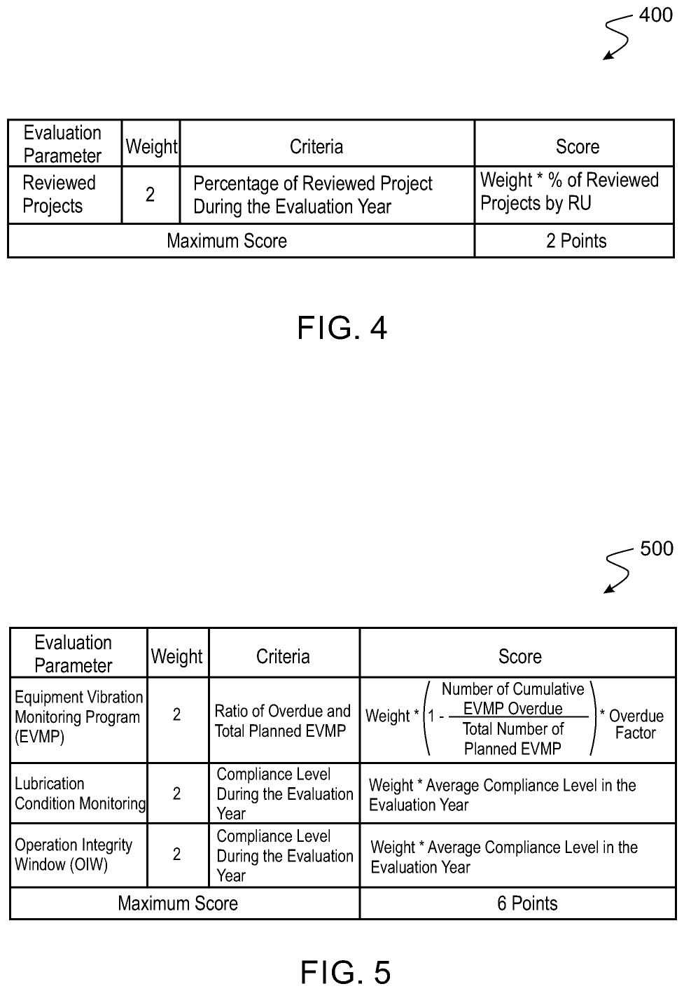

FIG. 4 is a table 400 showing criteria and scoring evaluations for a second element, namely, the preemptive work element, measured to evaluate the PRPI for the process plant. A maximum score allocated to the preemptive work element score is 2. The factor evaluated to determine the preemptive work element score for the process plant is the number of projects implemented by the reliability unit that needed review. If none of the projects needed review, then a maximum score is assigned to the preemptive work element. If projects needed review, then a score is determined based on a percentage of projects that needed review.

In some implementations, the computer system 200 (FIG. 2) receives as input, the total number of projects implemented by the reliability unit and a number of projects that needed review. For example, the input can be automatic or manual entry of the total and reviewed projects via an input device. The computer system 200 determines the preemptive work element score according to Eq. 2, which accounts for the weight (2) assigned to this score. The computer system 200 stores the preemptive work element score in the CRM 204.

$${Score}_{Preemptive work} = Weight \times [ \frac{Number of reviewed projects}{Total number of projects} ] \qquad ( Eq . 2 )$$

If the Number of reviewed projects in Eq. 2 is zero (0), then Eq. 2 is not executed and a full score of 1 is assigned to ScorePreemptive work.

FIG. 5 is a table 500 showing criteria and scoring evaluations for a third element, namely, the preventive work element, measured to evaluate the PRPI for the process plant. A maximum score allocated to the preventive work element score is 6. The first factor evaluated to determine the preventive work element score for the process plant is equipment vibration monitoring program (EVMP) evaluation. The EVMP evaluation score measures a ratio of overdue and total planned EVMP evaluations. A weight of 2 (two) is assigned to the EVMP evaluation score. The EVMP evaluation score is determined according to Eq. 3.

$${Score}_{EVMP Evaluation} = Weight \times [ 1 - \frac{No . of cumulative EVMP overdue}{Total number of planned EVMP} ] \times {F}_{Overdue} \qquad ( Eq . 3 )$$

Number of cumulative EVMP overdue means total number of overdue equipment against the total number of planned equipment under vibration monitoring program. In Eq. 3, the overdue factor is tied to a duration for which the EVMP evaluation is overdue. For example, the overdue factor is 100% if the EVMP is overdue more than 1 month, 75% if the EVMP is overdue by more than 3 months, 50% if the EVMP is overdue by more than 6 months and 25% if the EVMP is overdue by more than 1 year.

In some implementations, the computer system 200 (FIG. 2) receives as input, the actual number of EVMP evaluations overdue and the total number of planned EVMP evaluations. For example, the input can be automatic or manual entry of the overdue and planned EVMP evaluations via an input device. The computer system 200 also receives as input, the duration by which EVMP evaluation is overdue. The computer system 200 stores the weight assigned to the EVMP evaluation score. Using the inputs and the weight, the computer system 200 executes Eq. 3 to determine the EVMP evaluation score. The computer system 200 stores the EVMP evaluation score in the CRM 204.

The second factor evaluated to determine the preventive work element score for the process plant is lubrication condition monitoring (LCM). The LCM monitoring score measures lubrication condition monitoring compliance level during the evaluation year. In this context, the purpose of “LCM” is to ensure adequate lubrication of plant equipment. This metric measures the compliance of the collected oil samples on quarterly basis. A weight of 2 (two) is assigned to the LCM monitoring score. The LCM monitoring score is determined according to Eq. 4.

$${Score}_{LCM Monitoring} = Weight \times Avg . compliance level in eval year \qquad ( Eq . 4 )$$

The average compliance level in evaluation year calculates the average compliance of four quarters to calculate the yearly average to compare it with the target compliance of 90%.

In some implementations, the computer system 200 (FIG. 2) receives as input, the average compliance level in the evaluation year. For example, the input can be automatic or manual entry of the average compliance level in the evaluation year via an input device. The computer system 200 stores the weight assigned to the LCM monitoring score. Using the input and the weight, the computer system 200 executes Eq. 4 to determine the LCM monitoring score. The computer system 200 stores the LCM monitoring score in the CRM 204.

The third factor evaluated to determine the preventive work element score for the process plant is operation integrity window (OIW). The OIW monitoring score measures lubrication condition monitoring compliance level during the evaluation year. OIW represents a further limitation within the broader operating window of any measurable operating parameter which can suffer the mechanical integrity of the plant due to corrosion or degradation of the material when operated outside the OIW. The broader operating window is established from the process and equipment design, and is safeguarded by alarms, trips, pressure relief valves and other delimiting devices. But, it may not have fully addressed all possible degradation issues. Also, even if all potential degradation has been addressed during design, operational variations, design and construction faults and/or design changes can make the original design susceptible to degradation, which may further require limitation of the operating window. Therefore, OIWs are typically inside the operating range where “operations” are, in principle, allowed to work. An OIW is established only from measurable and controllable parameters. The parameters used to define an OIW have one or more of the following characteristics: parameters are either single, independently controlled process variable, such as temperature, pressure, pH, chemical injection rate, concentration, etc., or they are calculated variables′, for instance: flow ratios, dew point conditions, corrosion rates taken from OSI; the OIW can be based on a physical condition of the equipment, such as, degree of vibration, shin temperature etc. In addition to containing the operating parameters that directly affect mechanical integrity of the process, an OIW may also contain operating parameters related to other operational limits, such as fouling or foaming limit

A weight of 2 (two) is assigned to the OIW monitoring score. The OIW monitoring score is determined according to Eq. 5.

$${Score}_{OIW Monitoring} = Weight \times Avg . compliance level in evalution year \qquad ( Eq . 5 )$$

OIW is calculated for the entire year by taking the average of the four quarters. OIW focuses on controllable parameters to identify any deviations from normal operations.

In some implementations, the computer system 200 (FIG. 2) receives as input, the average compliance level in the evaluation year. For example, the input can be automatic or manual entry of the average compliance level in the evaluation year via an input device. The computer system 200 stores the weight assigned to the OIW monitoring score. Using the input and the weight, the computer system 200 executes Eq. 5 to determine the OIW monitoring score. The computer system 200 stores the OIW monitoring score in the CRM 204.

Having determined a score for each of the three factors as described above, the computer system 200 determines the preventive element score as a summation of the score determined for each factor. The maximum score for each factor is 2. Therefore, the maximum preventive element score can be 6.

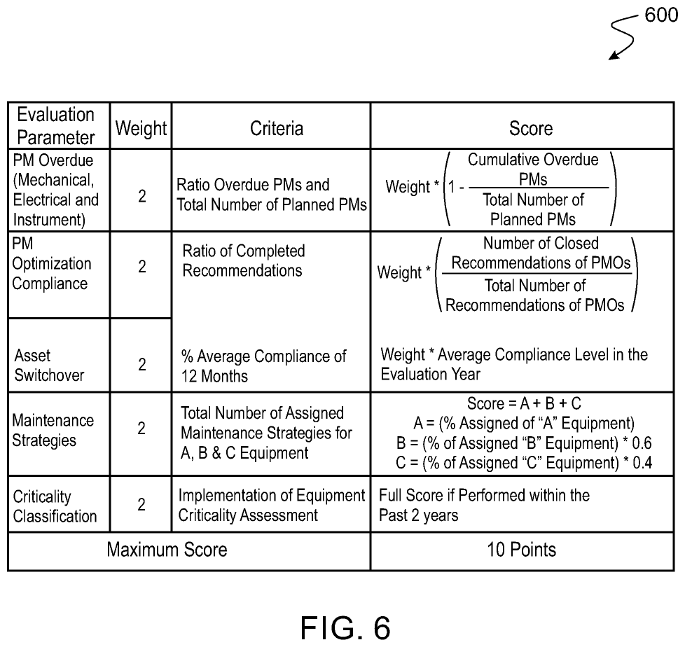

FIG. 6 is a table 600 showing criteria and scoring evaluations for a fourth element, namely, the predictive work element, measured to evaluate the PRPI for the process plant. A maximum score allocated to the predictive work element score is 10. The first factor evaluated to determine the predictive work element score for the process plant is PM overdue evaluation. The PM overdue score measures a ratio of overdue and total planned PM evaluations. In this context, the purpose of “PM overdue” is to evaluate the number of conducted PM against the plan, and accordingly calculate the overdue PMs in order to evaluate the performance of the PM program at the department. PM optimization (PMO) is a structured, continuous improvement process with the objective of balancing maintenance costs and the risk of failure. PMO evaluates and refines existing PM activities to verify that they are truly adding value by identifying potential gaps in PM performance and frequency. The evaluation of overdue PM will be performed throughout the year as the purpose is to minimize the number of overdue PMs. A weight of 2 (two) is assigned to the PM overdue score. The PM overdue score is determined according to Eq. 6.

$${Score}_{PM overdue} = Weight \times [ 1 - \frac{No . of cumulative PM overdue}{Total number of planned PMs} ] \qquad ( Eq . 6 )$$

Number of cumulate PM overdue means total number of overdue PMs (not conducted PMs) against the planned PMs throughout the whole year.

In some implementations, the computer system 200 (FIG. 2) receives as input, the cumulative number of PMs overdue and the total number of planned PMs. For example, the input can be automatic or manual entry of the overdue and planned PMs via an input device. The computer system 200 stores the weight assigned to the PM overdue score. Using the input and the weight, the computer system 200 executes Eq. 6 to determine the PM overdue score. The computer system 200 stores the PM overdue score in the CRM 204.

The second factor evaluated to determine the predictive work element score for the process plant is PM optimization compliance. The PM optimization compliance score measures a ratio of closed recommendations of PM optimizations and total number of recommended PM optimizations. In this context, the purpose of “PM optimization” is to generate a list of all open recommendations and follow up with operation engineering to issue the required documents. To perform PM optimization compliance, a reliability unit generates a list of all open recommendations (interval decrease recommendation only) and follows up with operation engineering to issue required compliance documents. A weight of 2 (two) is assigned to the PM optimization compliance score. The PM optimization compliance score is determined according to Eq. 7.

$${Score}_{PM optimization compliance} = Weight \times [ \frac{No . of closed PMO recommendations}{Total number of PMO recommendations} ] \qquad ( Eq . 7 )$$

Number of closed PMO recommendations calculates the closure percentage of closed recommendations against the total number of generated recommendations.

In some implementations, the computer system 200 (FIG. 2) receives as input, the number of closed PMO recommendations and the total number of PMO recommendations. For example, the input can be automatic or manual entry of the closed and planned PMOs via an input device. The computer system 200 stores the weight assigned to the PM optimization compliance score. Using the input and the weight, the computer system 200 executes Eq. 7 to determine the PM optimization compliance score. The computer system 200 stores the PM optimization compliance score in the CRM 204.

The third factor evaluated to determine the predictive work element score for the process plant is asset switchover. The asset switchover score measures compliance with the initiated switchover plan for the whole operating year. In this context, the purpose of asset switchover is to implement a regular operational switchover between duty and standby assets within a system with online sparing strategy. A weight of 2 (two) is assigned to the asset switchover score. The asset switchover score is determined according to Eq. 8.

$${Score}_{Asset switchover} = Weight \times Avg . compliance level in eval year \qquad ( Eq . 8 )$$

The average compliance level in evaluation year calculates the compliance of switchover strategy against the defined target for switchover through the whole year.

In some implementations, the computer system 200 (FIG. 2) receives as input, the average compliance level in the evaluation year. For example, the input can be automatic or manual entry of the average compliance level in the evaluation year via an input device. The computer system 200 stores the weight assigned to the asset switchover score. Using the input and the weight, the computer system 200 executes Eq. 8 to determine the asset switchover score. The computer system 200 stores the asset switchover score in the CRM 204.

The fourth factor evaluated to determine the predictive work element score for the process plant is maintenance strategies. The maintenance strategies score measures a total number of assigned maintenance strategies for each asset, e.g., equipment A, B and C, the reliability unit. Maintenance strategies are assigned for plant equipment based on asset criticality and potential failure modes and consequences. A weight of 2 (two) is assigned to the maintenance strategies score. The maintenance strategies score is determined by executing the rules shown in Eqs. 9-12.

$$A = \% assigned of “ A ” equipment \qquad ( Eq . 9 )$$

$$B = \% assigned of “ B ” equipment \times 0.6 \qquad ( Eq . 10 )$$

$$C = \% assigned of “ C ” equipment \times 0.4 \qquad ( Eq . 11 )$$

$$Score = A + B + C \qquad ( Eq . 12 )$$

In Eqs. 9-12, “A,” “B,” and “C” represent critical equipment, important equipment and ordinary equipment, respectively. The “% assigned” represents the distribution of A, B, C classifications among plant equipment. The score for “B” equipment is multiplied by 0.6 whereas the score for “C” equipment is multiplied by 0.4 based on the criticality of the equipment.

In some implementations, the computer system 200 (FIG. 2) receives as input, the number of assigned strategies to evaluate each equipment. For example, the input can be automatic or manual entry of the number of assigned strategies to evaluate each equipment. The computer system 200 stores the weight assigned to the maintenance strategies score. Using the input and the weight, the computer system 200 executes Eqs. 9-12 to determine the maintenance strategies score. The computer system 200 stores the maintenance strategies score in the CRM 204.

The fifth factor evaluated to determine the predictive work element score for the process plant is criticality classification. The criticality classifications score measures implementation of equipment criticality assessment. The criticality assessment is performed according to an industry standard, e.g., SABP-A-084, at a predetermined frequency, e.g., once every two years. For each asset in the reliability unit, if the criticality assessment has been performed according to the industry standard at the predetermined frequency (e.g., within the last two years), then a full score is assigned for the criticality classification score (i.e., a score of 1). The asset criticality assessment (ACA) study is mandated to be performed every two years. So, if the study exceeds 2 years without being performed, then the score is zero (0).

In some implementations, the computer system 200 (FIG. 2) receives as input, the number of criticality classifications for each equipment. For example, the input can be automatic or manual entry of the number of criticality classifications for each equipment. The computer system 200 stores the weight assigned to the criticality classifications score. Using the input and the weight, the computer system 200 determines the criticality classifications score. The computer system 200 stores the criticality classifications score in the CRM 204.

Having determined a score for each of the five factors as described above, the computer system 200 determines the predictive element score as a summation of the score determined for each factor. The maximum score for each factor is 2. Therefore, the maximum predictive element score can be 10.

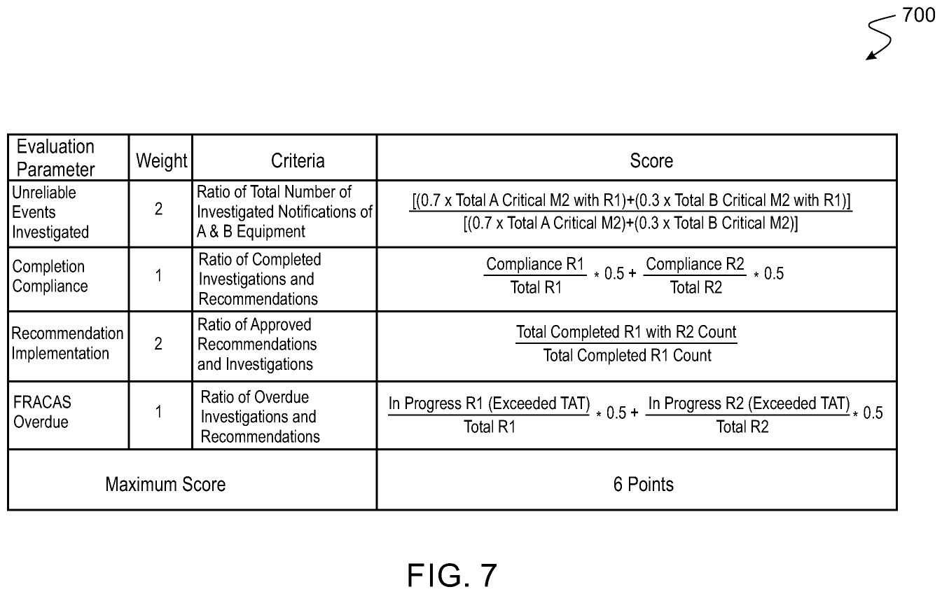

FIG. 7 is a table 700 showing criteria and scoring evaluations for a fifth element, namely, diagnostic work element, measured to evaluate the PRPI for the process plant. A maximum score allocated to the diagnostic work element score is 6. The first factor evaluated to determine the diagnostic work element score for the process plant is unreliable events investigated. The unreliable events investigated score measures a ratio of total number of investigated notifications of equipment. In this context, the purpose of unreliable events investigated is to investigate failures, defects and trips to identify the main root cause. A and B equipment classification are based on asset criticality assessment. A weight of 2 (two) is assigned to the unreliable events investigated score. The unreliable events investigated score is determined according to Eq. 13.

$${Score}_{Unreliable Events Investigated} = \frac{[ ( 0.7 \times Total A Critical M 2 with R 1 ) + ( 0.3 \times Total B Critical M 2 with R 1 ) ]}{[ ( 0.7 \times Total A Critical M 2 ) + ( 0.3 \times Total B Critical M 2 ) ]} \qquad ( Eq . 13 )$$

In Eq. 13, M2 is the maintenance notification for unreliable event (failure, defect or trip). R1 is the investigation notification which is generated systematically once an M2 is created.

In some implementations, the computer system 200 (FIG. 2) receives as input, each variable in Eq. 13. The computer system 200 stores the weight assigned to the PM overdue score. Using the input and the weight, the computer system 200 executes Eq. 13 to determine the unreliable events investigated score. The computer system 200 stores the unreliable events investigated score in the CRM 204.

The second factor evaluated to determine the diagnostic work element score for the process plant is completion compliance. The completion compliance score measures a ratio of completed investigations and recommendations. Completed investigations (R1s) means the assigned team has completed the investigation for the unreliable event by performing the fault tree analysis and the 5 “whys.” Completion compliance is defined by meeting a Turn Around Time (TAT) where all completed investigations (R1) and recommended investigations (R2) are included with a weight of 50% each. A weight of 1 (one) is assigned to the completion compliance score. The completion compliance score is determined according to Eq. 14.

$${Score}_{Completion compliance} = ( \frac{Compliance R 1}{Total R 1} \times 0.5 ) + ( \frac{Compliance R 2}{Total R 2} \times 0.5 ) \qquad ( Eq . 14 )$$

Compliance R1 is represented through the completion of the investigation within the specified duration (e.g., 45 days). Total R1 is the total number of assigned investigations. Compliance R2 is represented through the completion of the recommendation within the specified duration (e.g., 6, 9 or 12 months). Total R2 is the total number of generated recommendations.

In some implementations, the computer system 200 (FIG. 2) receives as input, the Compliance R1, Total R1, Compliance R2 and Total R2. For example, the input can be automatic or manual entry of the variables via an input device. The computer system 200 stores the weight assigned to the completion compliance score. Using the input and the weight, the computer system 200 executes Eq. 14 to determine the completion compliance score. The computer system 200 stores the completion compliance score in the CRM 204.

The third factor evaluated to determine the diagnostic work element score for the process plant is recommendation implementation. The recommendation implementation score measures a ratio of approved recommendations and investigations. The recommendation implementation score is a key performance indicator (KPI) which represents the ratio of approved recommendations (R2) over the completed investigations (R1). Once the investigation is completed by the assigned team/leader, the leader has to generate a recommendation which requires to be approved by the supervisor team along with the leaders of the implementations teams. These are approved recommendations. A weight of 2 (two) is assigned to the recommendation implementation score. The recommendation implementation score is determined according to Eq. 15.

$${Score}_{Recommendation implementation} = \frac{Total Completed R 1 with R 2 Count}{Total Completed R 1 Count} \qquad ( Eq . 15 )$$

All completed investigations have approved recommendations. Eq. 15 calculates the ratio between completed investigations (R1s) with approved recommendations (R2s) and the total number of completed investigations.

In some implementations, the computer system 200 (FIG. 2) receives as input, the Total Completed R1 with R2 count and Total Completed R1 count. For example, the input can be automatic or manual entry via an input device. The computer system 200 stores the weight assigned to the recommendation implementation score. Using the input and the weight, the computer system 200 executes Eq. 15 to determine the recommendation implementation score. The computer system 200 stores the recommendation implementation score in the CRM 204.

The fourth factor evaluated to determine the diagnostic work element score for the process plant is FRACAS overdue. FRACAS means failure reporting analysis and corrective actions system. The FRACAS overdue score measures a ratio of overdue investigations and recommendations. Overdue investigation or recommendation is defined as exceeding the specified time to complete the investigation or recommendation. FRACAS overdue is a KPI that represents all investigations and recommendations which are in process and have exceeded the TAT based on the following rules: (i) overdue R1 is 45 days in progress; (ii) overdue R2 is set depending on R2 priority—6 months for priority 1, 9 months for priority 2, 12 months for priority 3. R1 is investigation notification. R2 is recommendation notification. Priority provides the time frame required to complete the assigned recommendation based on urgency. For example, priority 1 recommendation has to be completed within 6 months; priority 2 within 9 months; priority 3 within 12 months. A weight of 1 (one) is assigned to the maintenance strategies score. The maintenance strategies score is determined by executing the rules shown in Eq. 16.

$${Score}_{FRACAS overdue} = ( \frac{In progress R 1 ( Exceeded TAT )}{Total R 1} \times 0.5 ) + ( \frac{In progress R 2 ( Exceeded TAT )}{Total R 2} \times 0.5 ) \qquad ( Eq . 16 )$$

The first term on the right hand side of Eq. 16 is the ratio of number of incomplete investigations and total number of assigned investigations. The second term on the right hand side of Eq. 16 is the ratio of number of incomplete recommendations and total number of assigned recommendations.

In some implementations, the computer system 200 (FIG. 2) receives as input, the variables in Eq. 16. For example, the input can be automatic or manual entry of the variables to evaluate the FRACAS overdue score. The computer system 200 stores the weight assigned to the FRACAS overdue score. Using the input and the weight, the computer system 200 executes Eq. 16 to determine the FRACAS overdue score. The computer system 200 stores the FRACAS overdue score in the CRM 204.

Having determined a score for each of the four factors as described above, the computer system 200 determines the diagnostic work score as a summation of the score determined for each factor. The maximum score for the four factors is 2, 1, 2 and 1, respectively. Therefore, the maximum predictive element score can be 6.

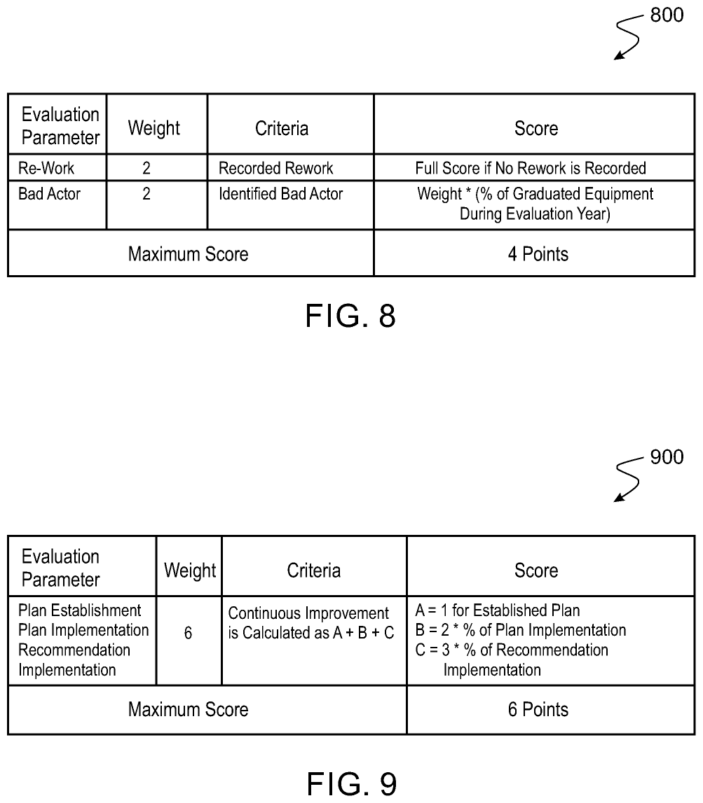

FIG. 8 is a table 800 showing criteria and scoring evaluations for a sixth element, namely, a corrective work element, measured to evaluate the PRPI for the process plant. A maximum score allocated to the corrective work element score is 4. The first factor evaluated to determine the corrective work element score for the process plant is re-work, which is recorded re-work. If an equipment is sent back to the repair shop within an agreed period of re-work (e.g., 6 months), then this is labeled as re-work. If no re-work is recorded, then a full score (e.g., 1) is assigned to the re-work factor. If re-work is recorded, then less than a full score (e.g., 0) is assigned to the re-work factor. In some implementations, the computer system 200 (FIG. 2) receives as input, whether or not a re-work has been recorded. The computer system 200 stores the weight assigned to the re-work factor score. Using the input and the weight, the computer system 200 determines a score for the re-work factor. The computer system 200 stores the score for the re-work factor in the CRM 204.

The second factor evaluated to determine the corrective work element score for the process plant is bad actor, which is identified bad actor. An equipment can be designated as a bad actor if: the equipment experiences two failures of the same failure mode in a cycle of 12 months; the equipment experiences more than two failures of different failure modes in a cycle of 12 months; the equipment experiences failure that has high repair cost. The bad actor score is determined by multiplying a weight assigned to the bad actor score (a weight of 2) by the percentage of graduated equipment during evaluation year. The percentage of graduated equipment is the ratio of graduated equipment and the total number of equipment labeled as bad actors. Graduation is granted if all recommendations and implemented and no failure has taken place during a specified period of time after recommendation implementation. In some implementations, the computer system 200 (FIG. 2) receives as input the number of equipment and the number of graduated equipment during evaluation year. The computer system 200 stores the weight assigned to the re-work factor score. Using the input and the weight, the computer system 200 determines a bad actor score as described earlier. The computer system 200 stores the bad actor score in the CRM 204.

Having determined a score for each of the two factors as described above, the computer system 200 determines the corrective work score as a summation of the score determined for each of the two factors. The maximum score for the two factors is 2, each. Therefore, the maximum corrective work element score can be 4.

FIG. 9 is a table showing criteria and scoring evaluations for a seventh element, namely, continuous improvement work, measured to evaluate the PRPI for the process plant. A maximum score allocated to the continuous improvement work element score is 6. The factors evaluated to determine the continuous improvement work element score for the process plant include plan establishment, plan implementation and recommendation implementation. Continuous improvement work refers to all ongoing reliability activities, which do not necessarily result from unreliable events, done to monitor and review the reliability management systems for improvement purposes. Each of the factors—plan establishment, plan implementation, and recommendation implementation—has a respective numerical value. These values are established in-house based on importance of each parameter. So, the sum of the scores equals 6. To determine the continuous improvement work score, a score of 1 is allocated for each established plan (A), 2 is allocated for percentage of plan implementation (B), and 3 for percentage of recommended implementations (C). The continuous improvement score is determined as A+B+C. In some implementations, the computer system 200 (FIG. 2) receives as input, the numerical values for plan establishment, plan implementation and recommendation implementation. The computer system 200 stores the weight (6) assigned to the continuous improvement work score. Using the input and the weight, the computer system 200 determines a score for each of A, B and C, and sums the three to determine the continuous improvement work score. The computer system 200 stores the continuous improvement work score in the CRM 204.

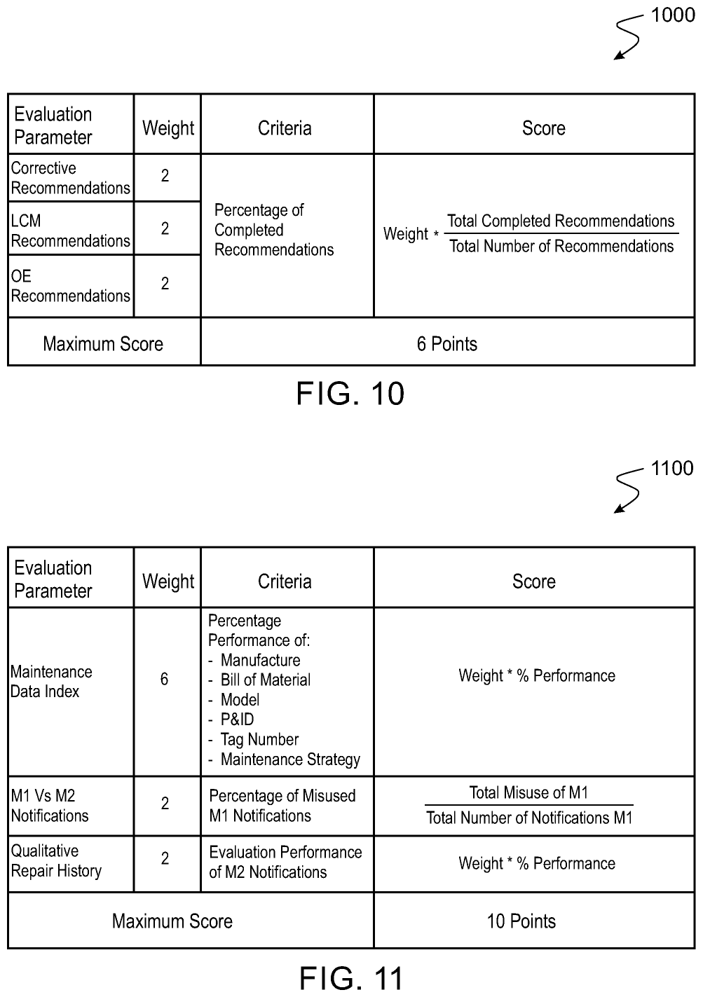

FIG. 10 is a table 1000 showing criteria and scoring evaluations for an eighth element, namely, a management of recommendations element, measured to evaluate the PRPI for the process plant. A maximum score allocated to the management of recommendations element score is 6. The first factor evaluated to determine the management of recommendations element score for the process plant is corrective recommendations. The second factor evaluated is lubrication control monitoring (LCM) recommendations. The third factor evaluated is original equipment (OE) recommendations. Each factor is evaluated as a percentage of total completed recommendations relative to total number of recommendations. The resulting value is multiplied by a weight (2) assigned to each factor. In some implementations, the computer system 200 (FIG. 2) receives as input, the total completed recommendations and total number of recommendations for each factor. The computer system 200 stores the weight assigned to each factor. Using the input and the weight, the computer system 200 determines a score for each factor as described above, and sums the scores to determine the management of recommendations score. The computer system 200 stores the management of recommendations score in the CRM 204.

FIG. 11 is a table showing criteria and scoring evaluations for a ninth element, namely, a data assessment element, measured to evaluate the PRPI for the process plant. A maximum score allocated to the data assessment element score is 10. The first factor evaluated to determine the data assessment element score for the process plant is maintenance data index. The maintenance data index is a KPI and evaluates a percentage performance of multiple sub-categories including manufacture, bill of material, model, P&ID, tag number and maintenance strategy. In this context, the percentage performance means maintenance data index (MDI), which is a percentage based on the performance of 6 criteria. So, the performance is converted to solid score out of 6. A weight of 6 (six) is assigned to the maintenance data index score. The maintenance data index score is determined by multiplying the weight by the percentage performance for the index. In some implementations, the computer system 200 (FIG. 2) receives as input, the percentage performance for each sub-category monitored in the index. The computer system 200 stores the weight assigned to the maintenance data index score. Using the input and the weight, the computer system 200 determine the maintenance data index score as described earlier. The computer system 200 stores the maintenance data index score in the CRM 204.

The second factor evaluated to determine the data assessment element score for the process plant is M1 vs M2 notifications. M1 notification (or M1) is for general maintenance request (preventive). M2 notification (or M2) is for corrective maintenance request (corrective). The notification score is evaluated as a percentage of misused M1 notifications. The notifications score score is determined according to Eq. 17.

$${Score}_{Notifications} = \frac{Total misuse of M 1}{Total Number of Notification M 1} \qquad ( Eq . 17 )$$

Misuse of M1 means using M1 for corrective action. Therefore, Eq. 17 calculates the ratio of misused M1 and the total number of M1s.

In some implementations, the computer system 200 (FIG. 2) receives as input, the total misuse of M1 and the total number of notifications M1. For example, the input can be automatic or manual entry of the variables via an input device. The computer system 200 stores the weight assigned to the notifications score. Using the input and the weight, the computer system 200 executes Eq. 17 to determine the notifications score. The computer system 200 stores the notifications score in the CRM 204.

The third factor evaluated to determine the data assessment element score for the process plant is qualitative repair history. The qualitative repair history score measures evaluation performance of M2 notifications. M2 notification has 11 fields to be completed, using which the evaluation performance is measured considering the quality of the data entry of the 11 fields. A weight of 2 (two) is assigned to the qualitative repair history score. The qualitative repair history score is determined as a product of the weight and percentage performance. Qualitative repair history is evaluated on a monthly basis on the generated M2s so that the reliability index calculates the performance of qualitative repair history as a score out of 2. In some implementations, the computer system 200 (FIG. 2) receives as input, the numerical values of the variables to measure the qualitative repair history. For example, the input can be automatic or manual entry via an input device. The computer system 200 stores the weight assigned to the qualitative repair history score. Using the input and the weight, the computer system 200 executes Eq. 15 to determine the qualitative repair history score. The computer system 200 stores the qualitative repair history score in the CRM 204.

Having determined a score for each of the three factors as described above, the computer system 200 determines the data assessment score as a summation of the score determined for each of the three factors. The maximum score for the three factors is 6, 2 and 2, respectively. Therefore, the maximum corrective work element score can be 10.

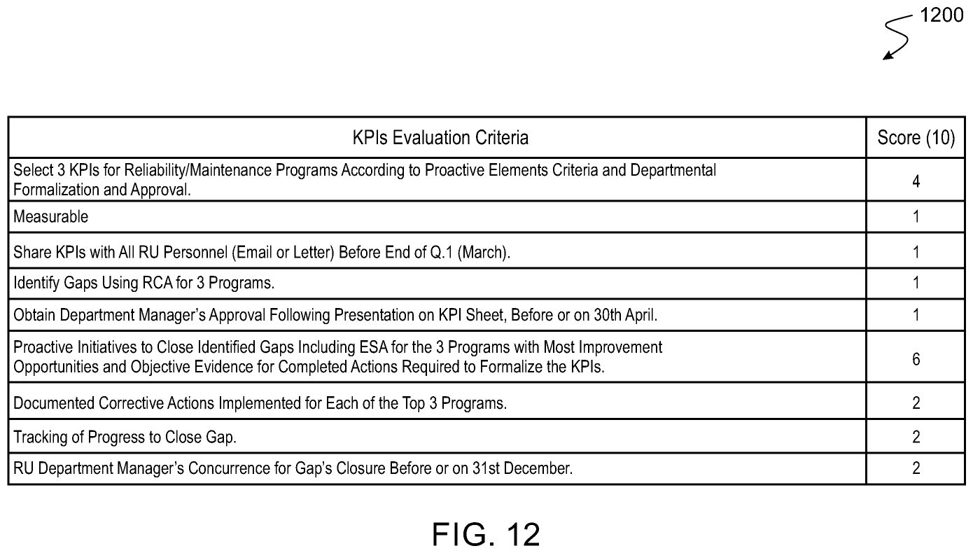

FIG. 12 is a table showing criteria and scoring evaluations for a tenth element, namely, KPIs evaluation criteria, measured to evaluate the PRPI for the process plant. The KPIs evaluation criteria is evaluated by evaluating two factors—the first having a maximum score of 4 and the second having a maximum score of 6, for a maximum total score of 10. The first factor is divided into four sub-factors, each of which has a score of 1 (one). The second factor is divided into three sub-factors, each of which has a score of 2 (two).

The first factor evaluated to determine the KPIs evaluation criteria score is to select 3 KPIs for reliability/maintenance programs according to proactive elements criteria and departmental formalization and approval. The identified programs can be those which offer the most improvement opportunities. Top five challenge programs can be selected and related gaps can be identified. The practical solutions utilized in incrementally closing identified gaps can be tracked. Closure can be validated so that implemented actions can be shared across the process plant. The submission can include a description of the KPI goal, measured item, measurement value, period covered and target objective for the year as formalized in the 1 st quarter and the actual achieved as documented in the 4th quarter.

The first sub-factor affecting the first factor include the measurability. That is, the KPI evaluation criteria should be measurably prorated over three reliability programs. The second sub-factor is sharing. That is, KPIs should be shared with reliability unit personnel before end of Q1. The third sub-factor is gap identification. That is, the reliability unit should identify gaps for the top three weakest programs within the reliability unit and that have the most improvement opportunities supported by root cause analysis. For each identified gap, the maximum score is 0.34 points, meaning for the three programs, the maximum possible score is 1 (3×0.34). The fourth sub-factor is obtaining approval following presentations on KPI sheets before the end of the quarter (i.e., by 30^{th} April).

The second factor evaluated to determine the KPIs evaluation criteria is to identify and implement proactive initiatives to close identified gaps for the programs with most improvement opportunities and identify objective evidence for completed actions required to formalize the KPIs. The first sub-factor affecting the second factor is documentation of corrective actions implemented for each of the top 3 programs. The maximum score for the documented action for each program is 0.67, meaning for the three programs, the maximum possible score for this sub-factor is 2 (3×0.67). The second sub-factor affecting the second factor is tracking of progress to close gap. Evidence of tracking of progress towards close of gaps shall gain 0.67 points for each of the three programs, meaning that the maximum possible score for this sub-factor is also 2. The third sub-factor is concurrence by the reliability unit's manager for gap closure before end of the calendar year. Concurrence by the manager shall result in a score of 0.67 (the full score) per program being assigned for this sub-factor.

In some implementations, the computer system 200 (FIG. 2) receives as input, the numerical values for each sub-factor evaluated in the KPIs evaluation criteria scoring. For example, the input can be automatic or manual entry via an input device. Using the input, the computer system 200 sums the numerical values received for each sub-factor as described above to determine a score for each factor, and using the score for each factor, to determine the KPIs evaluation criteria score. Therefore, the maximum KPIs evaluation criteria score can be 10.

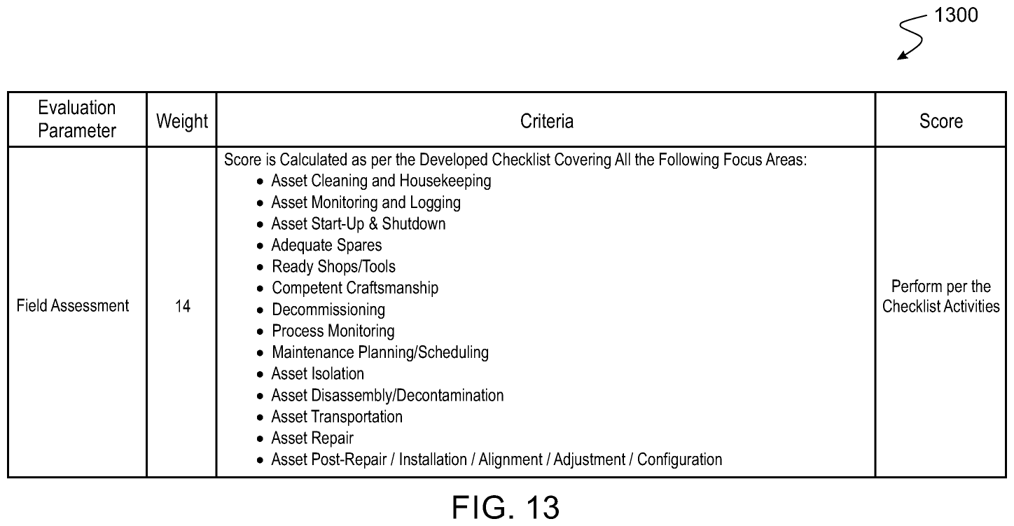

FIG. 13 is a table 1300 showing criteria and scoring evaluations for an eleventh element, namely, a field assessment element, measured to evaluate the PRPI for the process plant. The field assessment element score is given a weight of 14. The field element score is determined based on a checklist covering multiple focus areas including asset cleaning and housekeeping, asset monitoring and logging, asset start-up and shutdown, adequate spares, ready shops/tools, competent craftsmanship, decommissioning, process monitoring, maintenance planning/scheduling, asset isolation, asset disassembly/decontamination, asset transportation, asset repair, asset post-repair/installation/alignment/adjustment/configuration. The intent is that the reliability units shall maintain the effectiveness of all the reliability programs and their related focus areas. The field assessment is conducted by a team and input for the field assessment score determination is submitted by the team. The assessment is conducted within the scope of reliability programs. A checklist with scoring criteria is used for the listed reliability program and the related focus areas. Any lack of adherence to established standards is included in the findings. Field assessment findings are discussed within the reliability unit before reporting to give the reliability unit additional supporting documents. Root cause analysis is conducted for field assessment findings.

In some implementations, the computer system (FIG. 2) receives as input, numerical values for each item listed in the checklist shown in table 1300. The computer system 200 assigns scores to each item. The maximum score is 14, which the computer system 200 determines by adding the scores for each item. The computer system 200 stores the field assessment score in the CRM 204.

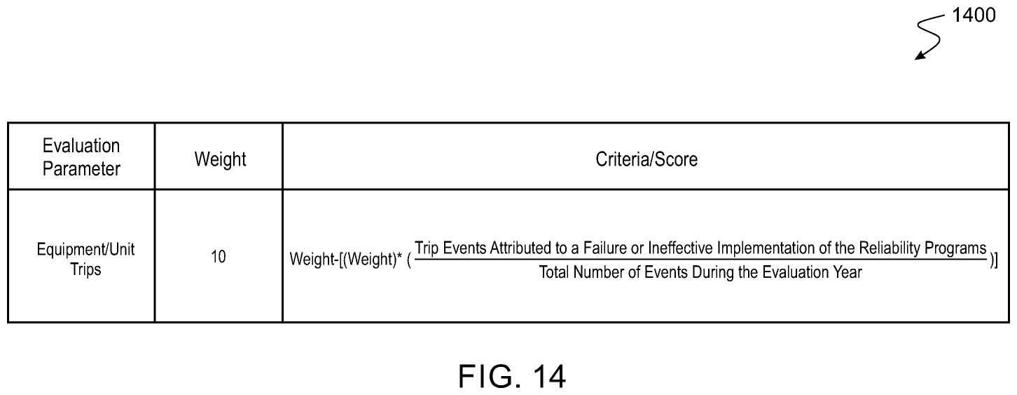

FIG. 14 is a table 1400 showing criteria and scoring evaluations for a twelfth element, namely, equipment events element, measured to evaluate the PRPI for the process plant. A maximum score allocated to the equipment events element score is 10. The equipment events covers the trip events occurred in the evaluation year. A trip event is similar to a failure with the difference being that the failure is automatically detected by a protection system that automatically shuts down the asset, instead of a manual shutdown. Therefore, a trip is an asset unplanned shutdown while operational. Once detected, the trip is reported in FRACAS, following the same work process of failures, as detailed for FRACAS. A score deduction will be applied if the trip event is attributed to a failure or ineffective implementation of the corporate reliability programs as outlined in causal factors and root causes of the investigation report. The equipment events element score is determined according to Eq. 18.

$$( Eq . 18 )$$

$${Score}_{Equipment events} = Weight - [ \text{} ( Weight ) \times ( \frac{\begin{matrix}Trip events due to failure or \\ ineffective implementation\end{matrix}}{\begin{matrix}Total number of events \\ during the evaluation year\end{matrix}} ) ]$$

The right hand side variable in Eq. 10 is the ratio of trips occurred due to ineffective implementation of reliability programs and the total number of trips during the evaluation year. The output will identify the trip percentage with a score out of 10.

In some implementations, the computer system 200 (FIG. 2) receives as input, each variable in Eq. 18. The computer system 200 stores the weight assigned to the equipment events score. Using the input and the weight, the computer system 200 executes Eq. 18 to determine the equipment events score. The computer system 200 stores the equipment events score in the CRM 204.

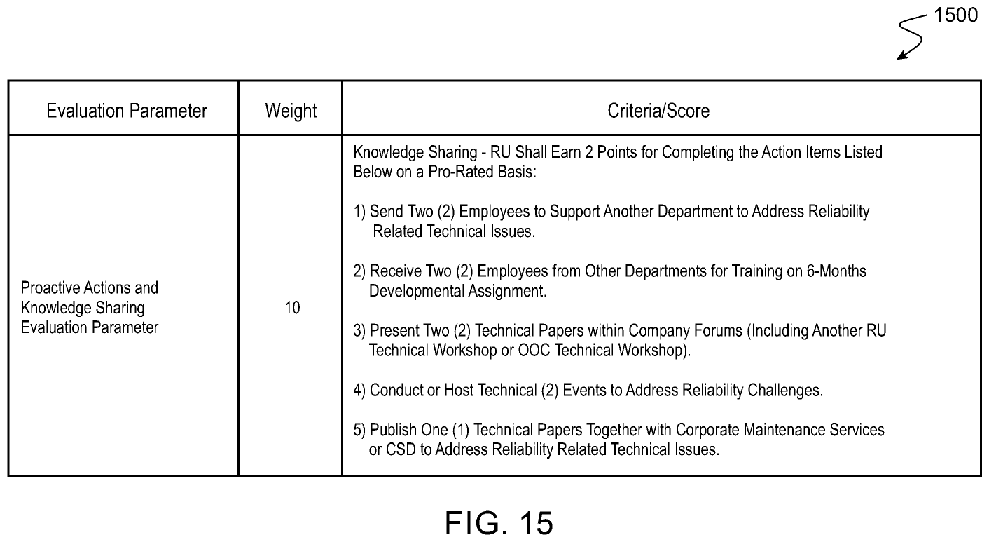

FIG. 15 is a table 1500 showing criteria and scoring evaluations for a thirteenth element, namely, knowledge sharing, measured to evaluate the PRPI for the process plant. The knowledge sharing score is evaluated based on proactive actions and knowledge sharing between reliability units. Knowledge sharing can be measured based on factors including (1) if a reliability unit sends employees (e.g., two employees) to support another department to address reliability-related technical issues; (ii) if a reliability unit receives employees (e.g., two employees) from other departments for training for a predetermined duration (e.g., six-month developmental assignment); (iii) if a reliability unit gives a technical presentation (e.g., presents two technical papers) within forums organized within the process plant; (iv) if a reliability unit conducts or hosts technical events to address reliability challenges, and (v) if a reliability unit publishes one technical paper to address reliability issues. In some implementations, the computer system 200 (FIG. 2) receives input for each of the five criteria listed here. The computer system 200 assigns a weight of 2 (two) per criteria. Based on the received input per criteria, the computer system 200 determines a score per criteria. The computer system 200 adds the scores per criteria to arrive at the knowledge sharing score.

In this manner, the computer system 200 determines a score for each of the 13 elements enumerated in table 100 (FIG. 1). The computer system 200 factors demerits, if any, due to late submission (row 106 in FIG. 1) and deductions, if any, due to lack of data integrity (row 108 in FIG. 1). The computer system 100 determines a total score by adding the score for each element and deducting scores for demerits. The computer system 200 determines a final score (or total score 110), and outputs the total score (row 110 in FIG. 1), e.g., on the output device 208 (FIG. 2).

The operations described in this specification can be implemented as operations performed by a data processing apparatus on data stored on one or more computer-readable storage devices or received from other sources.

The term “processor” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well, for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user, for example, by sending web pages to a web browser on a user's client device in response to requests received from the web browser.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

1. A computer-implemented method implemented in a process plant deploying a plurality of assets operating collectively to perform process plant operations, the method comprising:
receiving, from a plurality of sources, numerical input values representing a reliability of the plurality of assets operating in the process plant, the numerical input values classified into a plurality of reliability elements;
determining, using the numerical input values, a quantitative score for each reliability element of the plurality of reliability elements;
adjusting each quantitative score for each reliability element by a weight assigned to the reliability element;
aggregating the quantitative score for each reliability element to determine an aggregate score;
deducting, from the aggregate score, demerits directed to receiving the numerical input values after a threshold duration or directed to lack of integrity of the received numerical input values, resulting in a total score measuring a reliability of the process plant; and
providing the total score as an output in response to receiving the numerical input values.

2. The method of claim 1, wherein the plurality of reliability elements includes a reliability workforce element, a preemptive work element, a preventive work element, a predictive work element, a diagnostic work element, a corrective work element, a continuous improvement work element, a management of recommendations element, a data assessment element, a key performance indicator element, a field assessment and physical condition verification element, an equipment trips element and a knowledge sharing element.

3. The method of claim 2, wherein a reliability workforce element score for the reliability workforce element is determined using the formula:
$${Score}_{Manning Requirement} = Weight \times \frac{Actual number of reliability workforce}{Approved number of reliability workforce} .$$

4. The method of claim 2, wherein a preemptive work element score for the preemptive work element is determined using the formula:
$${Score}_{Preemptive work} = Weight \times [ \frac{Number of reviewed projects}{Total number of projects} ] .$$

5. The method of claim 2, wherein a preventive work element score for the preventive work element is determined using the formula:
$${Score}_{EVMP Evaluation} = Weight \times [ 1 - \frac{No . of cumulative EVMP overdue}{Total number of planned EVMP} ] \times {F}_{Overdue} .$$

6. The method of claim 2, wherein a predictive work element score for the predictive work element is determined using the formula:
$${Score}_{PM overdue} = Weight \times [ 1 - \frac{No . of cumulative PM overdue}{Total number of planned PMs} ] .$$

7. The method of claim 2, wherein a diagnostic work element score for the diagnostic work element is determined using the formula:
$${Score}_{Unreliable Events Investigated} = \frac{\begin{matrix}[ ( 0.7 \times Total A Critical M2 with R1 ) + \\ ( 0.3 \times Total B Critical M2 with R 1 ) ]\end{matrix}}{\begin{matrix}[ ( 0.7 \times Total A Critical M2 ) + \\ ( 0.3 \times Total B Critical M2 ) ]\end{matrix}} .$$

8. A computer-readable medium storing computer instructions which when executed by one or more processors is configured to perform a method implemented in a process plant deploying a plurality of assets operating collectively to perform process plant operations, the method comprising:
receiving, from a plurality of sources, numerical input values representing a reliability of the plurality of assets operating in the process plant, the numerical input values classified into a plurality of reliability elements;
determining, using the numerical input values, a quantitative score for each reliability element of the plurality of reliability elements;
adjusting each quantitative score for each reliability element by a weight assigned to the reliability element;
aggregating the quantitative score for each reliability element to determine an aggregate score;
deducting, from the aggregate score, demerits directed to receiving the numerical input values after a threshold duration or directed to lack of integrity of the received numerical input values, resulting in a total score measuring a reliability of the process plant; and
providing the total score as an output in response to receiving the numerical input values.

9. The medium of claim 8, wherein the plurality of reliability elements includes a reliability workforce element, a preemptive work element, a preventive work element, a predictive work element, a diagnostic work element, a corrective work element, a continuous improvement work element, a management of recommendations element, a data assessment element, a key performance indicator element, a field assessment and physical condition verification element, an equipment trips element and a knowledge sharing element.

10. The medium of claim 9, wherein a reliability workforce element score for the reliability workforce element is determined using the formula:
$${Score}_{Manning Requirement} = Weight \times \frac{Actual number of reliability workforce}{Approved number of reliability workforce} .$$

11. The medium of claim 9, wherein a preemptive work element score for the preemptive work element is determined using the formula:
$${Score}_{Preemptive work} = Weight \times [ \frac{Number of reviewed projects}{Total number of projects} ] .$$

12. The medium of claim 9, wherein a preventive work element score for the preventive work element is determined using the formula:
$${Score}_{EVMP Evaluation} = Weight \times [ 1 - \frac{No . of cumulative EVMP overdue}{Total number of planned EVMP} ] \times {F}_{Overdue} .$$

13. The medium of claim 9, wherein a predictive work element score for the predictive work element is determined using the formula:
$${Score}_{PM overdue} = Weight \times [ 1 - \frac{No . of cumulative PM overdue}{Total number of planned PMs} ] .$$

14. The medium of claim 9, wherein a diagnostic work element score for the diagnostic work element is determined using the formula:
$${Score}_{Unreliable Events Investigated} = \frac{\begin{matrix}[ ( 0.7 \times Total A Critical M2 with R1 ) + \\ ( 0.3 \times Total B Critical M2 with R 1 ) ]\end{matrix}}{\begin{matrix}[ ( 0.7 \times Total A Critical M2 ) + \\ ( 0.3 \times Total B Critical M2 ) ]\end{matrix}} .$$

15. A computer system comprising:
one or more processors; and
a computer-readable medium storing computer instructions which when executed by the one or more processors is configured to perform a method implemented in a process plant deploying a plurality of assets operating collectively to perform process plant operations, the method comprising:
receiving, from a plurality of sources, numerical input values representing a reliability of the plurality of assets operating in the process plant, the numerical input values classified into a plurality of reliability elements;
determining, using the numerical input values, a quantitative score for each reliability element of the plurality of reliability elements;
adjusting each quantitative score for each reliability element by a weight assigned to the reliability element;
aggregating the quantitative score for each reliability element to determine an aggregate score;
deducting, from the aggregate score, demerits directed to receiving the numerical input values after a threshold duration or directed to lack of integrity of the received numerical input values, resulting in a total score measuring a reliability of the process plant; and
providing the total score as an output in response to receiving the numerical input values.

16. The system of claim 15, wherein the plurality of reliability elements includes a reliability workforce element, a preemptive work element, a preventive work element, a predictive work element, a diagnostic work element, a corrective work element, a continuous improvement work element, a management of recommendations element, a data assessment element, a key performance indicator element, a field assessment and physical condition verification element, an equipment trips element and a knowledge sharing element.

17. The system of claim 16, wherein a reliability workforce element score for the reliability workforce element is determined using the formula:
$${Score}_{Manning Requirement} = Weight \times \frac{Actual number of reliability workforce}{Approved number of reliability workforce} .$$

18. The system of claim 16, wherein a preemptive work element score for the preemptive work element is determined using the formula:
$${Score}_{Preemptive work} = Weight \times [ \frac{Number of reviewed projects}{Total number of projects} ] .$$

19. The system of claim 16, wherein a preventive work element score for the preventive work element is determined using the formula:
$${Score}_{EVMP Evaluation} = Weight \times [ 1 - \frac{No . of cumulative EVMP overdue}{Total number of planned EVMP} ] \times {F}_{Overdue} .$$

20. The system of claim 16, wherein a predictive work element score for the predictive work element is determined using the formula:
$${Score}_{PM overdue} = Weight \times [ 1 - \frac{No . of cumulative PM overdue}{Total number of planned PMs} ] .$$
